(19) United States
(12) Patent Application Publication
(10) Pub. No.: US 2007/0140921 A1
(43) Pub. Date: Jun. 21, 2007

(54) System and method for shipping a saturated luminescent dissolved oxygen sensor

(75) Inventor: Thomas Owen Mitchell, Fort Collins, CO (US)

Correspondence Address: THE OLLILA LAW GROUP LLC, 2060 BROADWAY, SUITE 300, BOULDER, CO, 80302, US

(73) Assignee: HACH COMPANY

(21) Appl. No.: 11/312,194

(22) Filed: Dec. 20, 2005

(51) Int. Cl. B01L 3/00

(52) U.S. Cl. 422/102

(57) ABSTRACT

A method and apparatus for deploying a luminescent dissolved oxygen sensor where the luminescent material is already stable, is disclosed. The luminescent material of the sensor is shipped immersed in fluid. The luminescent material of the sensor may be pre-saturated in a fluid before shipping or may be allowed to saturate during shipping.

### BACKGROUND OF THE INVENTION

1. Field of the Invention

The invention is related to the field of sensors, and in particular, to a system and method for shipping a replacement part for a luminescent dissolved oxygen sensor in a saturated condition.

2. Statement of the Problem

The concentration of oxygen in water can be measured with a probe. The oxygen in the water interacts with a luminescent material on the outside of the probe. This interaction between the oxygen and the luminescent material results in a phenomenon known as luminescent quenching. Thus, the amount of luminescent quenching indicates the concentration of oxygen in the water.

In operation, the probe directs a light source centered at one wavelength onto the luminescent material. The light causes the luminescent material to generate luminescent light centered at a different wavelength. Luminescence quenching affects the amount of time that the luminescent material continues to luminescence light. Thus, if the light source's signal varies sinusoidally, the luminescence quenching affects the phase shift between the excitation light and the luminescent light. The probe uses an optical sensor to measures the phase shift between the excitation light and the luminescent light to assess the amount of luminescent quenching. As a result, the probe processes the phase shift to determine the concentration of oxygen in the water. An example of such a probe is disclosed in U.S. Pat. No. 6,912,050 entitled “Phase shift measurement for luminescent light” filed Feb., 3, 2003, which is hereby incorporated by reference.

Luminescent quenching of the luminescent material varies dependent on how long the luminescent material has been immersed in water. A dry sensor, when first immersed in water, will have a stable response for the concentration of oxygen in the water for a short period of time, typically up to two hours. As the luminescent material slowly becomes saturated with water, the luminescent response for a given oxygen concentration will slowly change. Once the luminescent material becomes fully saturated with water, typically after about three days, the luminescent response stabilizes. A user that replaces a luminescent oxygen sensor in the field with a dry sensor, may not get an accurate reading from the sensor for up to three days. After the probe stabilized, the user would still need to recalibrate the instrument to ensure the accuracy of the readings. Most users would like to start accurately measuring the oxygen concentration in the water as soon as the sensor is deployed.

Therefore there is a need for a system and method for deploying a luminescent dissolved oxygen sensor that is already stable.

### SUMMARY OF THE INVENTION

A method and apparatus for deploying a luminescent dissolved oxygen sensor where the luminescent material is already stable, is disclosed. The luminescent material of the sensor is shipped immersed in fluid or enclosed in a container with water saturated air. The luminescent material of the sensor may be pre-saturated before shipping or may be allowed to saturate during shipping.

### BRIEF DESCRIPTION OF THE DRAWINGS

FIG. 1 is an exploded view of luminescent dissolved oxygen sensor 100.

FIG. 2 is an exploded view of shipping container 200, in an example embodiment of the invention.

FIG. 3 a cross-sectional view of a side sensing luminescent dissolved oxygen sensor 300.

FIG. 4 is a cross-sectional view of an end sensing luminescent dissolved oxygen sensor 400.

FIG. 5 is an isometric view of field replaceable part 330.

FIG. 6 is a cross-sectional view of a lid for a shipping container in an example embodiment of the invention.

FIG. 7 is an exploded view of shipping container 700 in another example embodiment of the invention.

FIG. 8 is an exploded view of shipping container 800 in another example embodiment of the invention.

### DETAILED DESCRIPTION OF THE PREFERRED EMBODIMENT

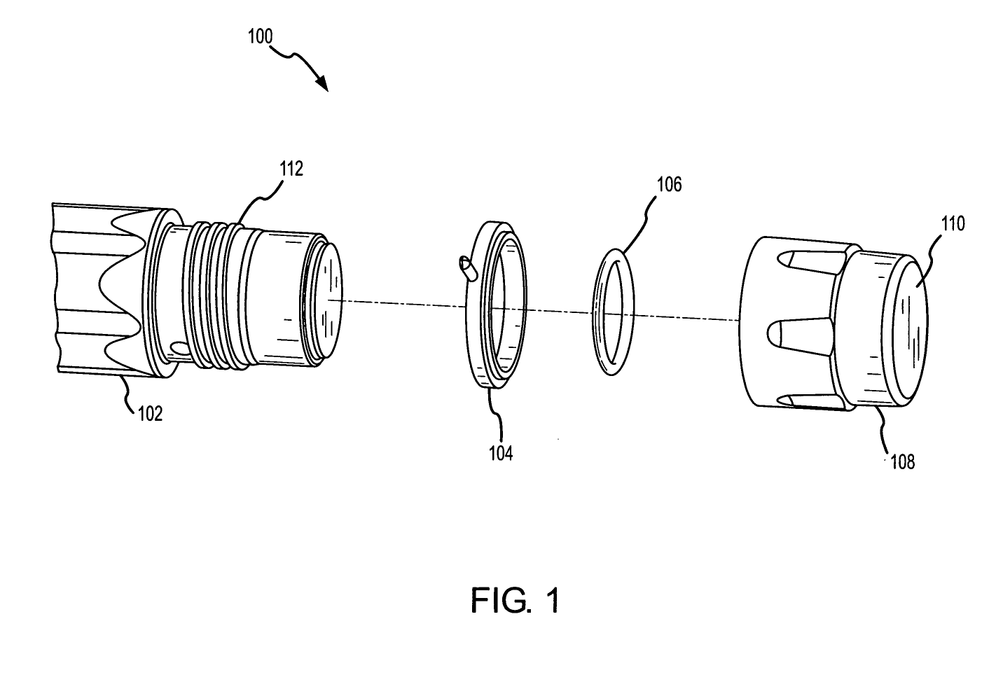

FIGS. 1-9 and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

Luminescent dissolved oxygen sensors (also called probes) are immersed in water during use. The luminescent material must be exposed to the water for the sensor to operate properly. The surface of the sensor exposed to the water may become fouled over time by biological growth or sediment. The fouled sensor may have reduced response time, inaccurate performance, or both. Removing the growth or sediment may damage the luminescent material and affect the sensor performance or accuracy. Some sensors solve this problem by using a field replaceable part that contains the luminescent material.

FIG. 1 is an exploded view of luminescent dissolved oxygen sensor 100. Luminescent dissolved oxygen sensor 100 comprises probe body 102, cap 108, O-ring 106, and seal 104. Cap 108 has a luminescent material deposited on face 110. Luminescent material 112 is typically a mix of Polystyrene and Platinum Porphynin. The luminescent material is covered by an optically opaque hydrostatically transparent material that allows water to penetrate to the luminescent material but prevents light from penetrating to the luminescent material. One example of an optically opaque hydrostatically transparent material is a mix of carbon lamp black and Polybutyl Methacrylate. Cap 108 is configured to screw onto threads 112 on probe body 102. O-ring 106 and seal 104 help form a water tight seal between cap 108 and body 102. Cap 108 is designed to be field replaceable. A user can remove the probe from the water, remove the fouled cap from the probe and replace it with a new cap, then re-install the probe back into the water. Unfortunately, if the field replaceable cap is dry, the probe readings may not stabilize for up to three days as the luminescent material on the new cap slowly becomes saturated with water.

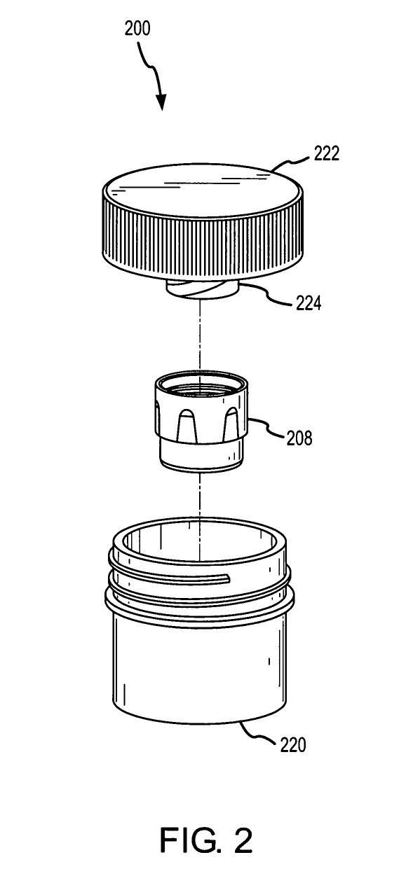

FIG. 2 is an exploded view of shipping container 200, in an example embodiment of the invention. Shipping container 200 comprises main body 220 and lid 222. Main body 220 has a cavity formed to hold liquid. Lid 222 is configured to attach to main body 220 and seal the cavity, forming a water tight container. Lid 222 can use a number of different fastening methods to attach to main body 220, for example lid may screw onto main body, lid may snap onto main body, or the like. An O-ring or gasket (not shown) may be used to help form the seal between lid 222 and main body 220. There is a mounting structure on the bottom side of lid 222 configured to hold field replaceable cap 208. The mounting structure on the bottom of lid 222 may take any number of shapes. In one example embodiment of the invention, the mounting structure replicates the threaded end of the probe body. The field replaceable cap is screwed onto the bottom of lid 222 that replicates the threaded end of the probe. A mounting structure may alternately be formed inside the cavity in the main body of the shipping container, instead of on the bottom of the lid.

In operation, field replaceable cap 208 is mounted onto the bottom of lid 222. Fluid is added to the cavity in main body 220. Lid 222 is attached to main body 220 sealing the cavity and holding field replaceable cap 208 into the cavity. In one example embodiment of the invention, the end of field replaceable cap 208 is held in the fluid when the lid 222 is attached to the main body 220. In another embodiment of the invention, the end of field replaceable cap 208 is held above the top level of the fluid and does not contact the fluid. In this embodiment, the fluid in the sealed cavity keeps the air in the cavity saturated with the fluid, thereby saturating the luminescent material. In one example embodiment of the invention, a sponge (not shown) may be installed in the cavity. The sponge may reduce the amount of fluid required in the cavity to keep the bottom of the field replaceable cap 208 saturated with the fluid. A heat shrink band (not shown) may be installed around the lid 222 of the shipping container to help prevent unwanted separation of the lid 222 from the main body 220.

In one example embodiment of the invention, a water tight seal is formed between the field replaceable cap 208 and the lid 222. An O-ring or gasket may be used to help form the water tight seal between the field replaceable cap 208 and the lid 222. The water tight seal prevents fluid in the shipping container from getting into the inner surface of field replaceable cap 208. Installing the field replaceable cap 208 onto a probe with water on the inner surface of the field replaceable cap 208 may cause inaccurate sensor measurements. Drying the inner surface of the field replaceable cap 208 may be difficult in the field. With a water tight seal between the field replaceable cap 208 and the lid 222, the user can just remove the lid from the body, remove the cap 208 from the lid 222, and attach the cap 208 to the probe body 102.

The luminescent material on the field replaceable part may take some time to fully saturate after being immersed in fluid. The time to saturate may be dependent on the thickness of the luminescent material, the thickness of the optically opaque hydrostatically transparent material covering the luminescent material, the part geometry, or the like. The saturation time can easily be determined. In some cases, the time needed to ship the field replaceable part to its destination may be less that the saturation time. In one example embodiment of the invention, the luminescent material on the replacement part is pre-saturated before being inserted into the shipping container. In another example embodiment of the invention, the replacement part is installed into the shipping container and then allowed to saturate in the shipping container before being shipped. A combination of pre-saturation time and shipping time may also be used to ensure that the luminescent material on the replacement part is fully saturated when the replacement part reaches its destination.

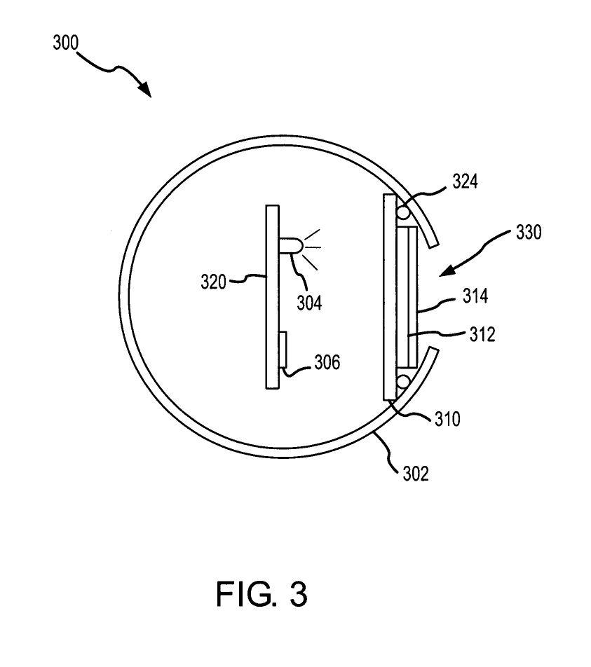

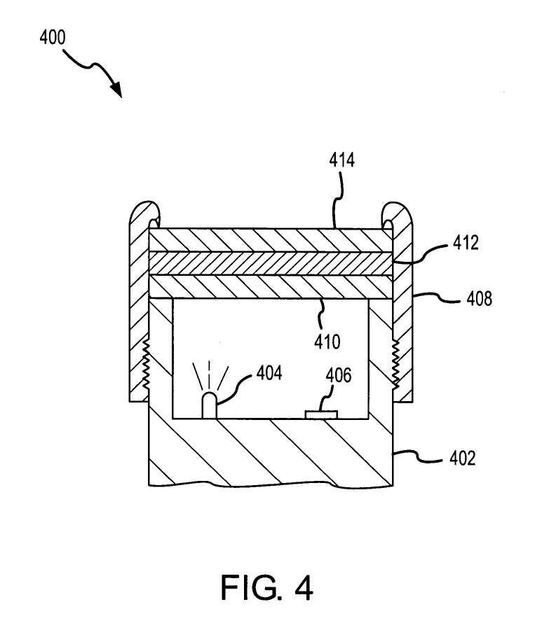

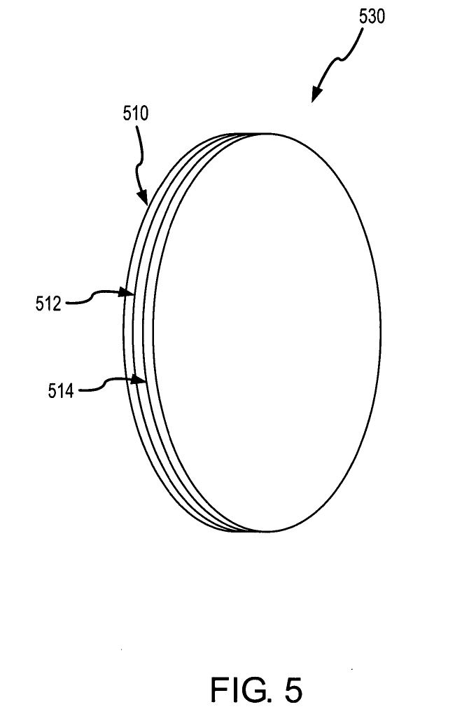

The field replaceable part containing the luminescent material need not be in the shape of a cap. FIG. 3 is a cross-sectional view of a side viewing luminescent dissolved oxygen sensor 300. Sensor 300 has field replaceable sensor part 330 comprising a hydrostatic barrier 310, a luminescent material 312, and an optically opaque hydrostatically transparent material 314 covering the luminescent material 312. FIG. 4 is a cross-sectional view of an end sensing luminescent dissolved oxygen sensor 400. Sensor 400 also has a field replaceable part comprising a hydrostatic barrier 410, a luminescent material 412, and an optically opaque hydrostatically transparent material 414 covering the luminescent material 412. FIG. 5 is an isometric view of field replaceable part 530 having hydrostatic barrier 510, a luminescent material 512, and an optically opaque hydrostatically transparent material 514. The drawings are not to scale and some thicknesses have been increased for clarity in explaining the invention, for example, in practice the optically opaque hydrostatically transparent material may only be a thin layer (10-20 microns) deposited over the other layers.

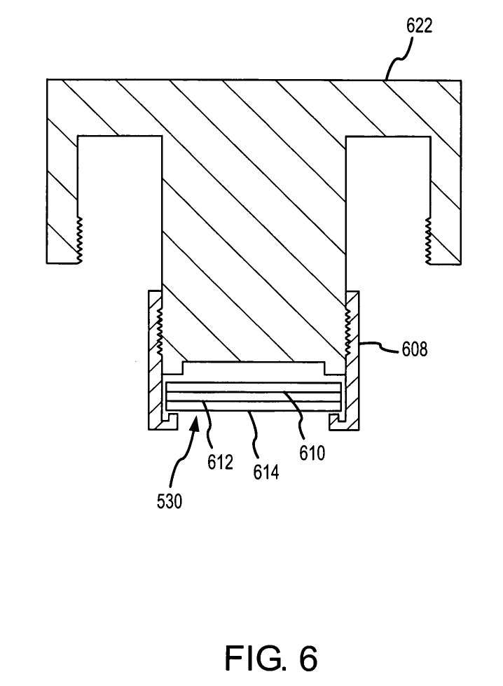

FIG. 6 is a cross-sectional view of a lid for a shipping container in an example embodiment of the invention. Lid 622 is configured to attach to the main body (not shown) of a shipping container. Lid 622 has a mounting feature formed in the bottom side of the lid used to hold a field replaceable part 630 containing a luminescent material similar to the part shown in FIG. 5. Field replaceable part 630 comprises a hydrostatic barrier 610, a luminescent material 612, and an optically opaque hydrostatically transparent material 614 covering the luminescent material 612. Field replaceable part 630 is held onto the mounting structure with retaining ring 608. A water tight seal may be formed between the mounting structure and field replaceable part 630 such that one side of field replaceable part 630 is kept dry during shipment. Lid 622 is attached onto the main body (not shown) of the shipping container thereby holding field replaceable part immersed in fluid. Because field replaceable part 630 is essentially flat, it may not be difficult to dry one side in the field. This may allow more flexibility in the design of the shipping container.

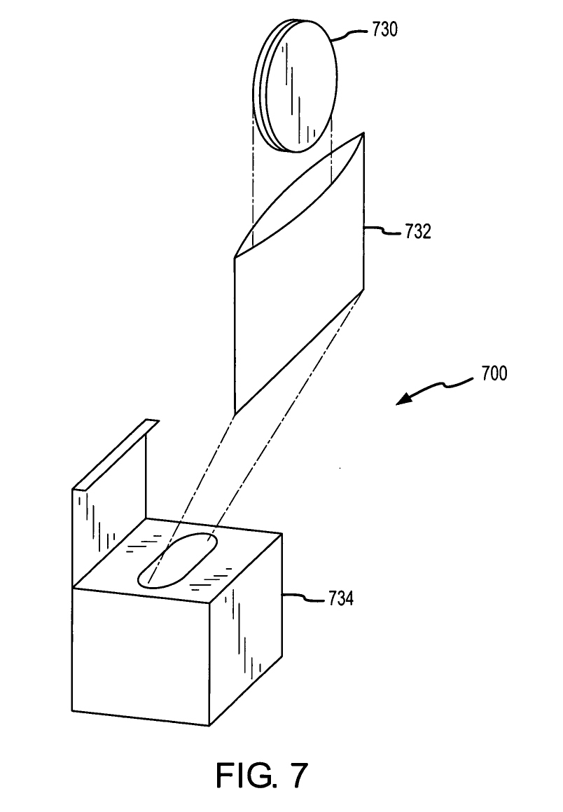

FIG. 7 is an exploded view of shipping container 700 in another example embodiment of the invention. Shipping container 700 comprises sealable bag 732 and shipping box 734. In operation, field replaceable part 730 is inserted into sealable bag 732. Fluid is added to sealable bag and then the bag is sealed. The sealed bag is inserted into shipping box 734. Shipping box 734 is configured to protect sealable bag 732 from rupture during shipment. When a user receives field replaceable part 730, the user will remove the bag from the shipping box, remove the part from the bag, dry the hydrostatic barrier side of the part, and then install the part into the probe.

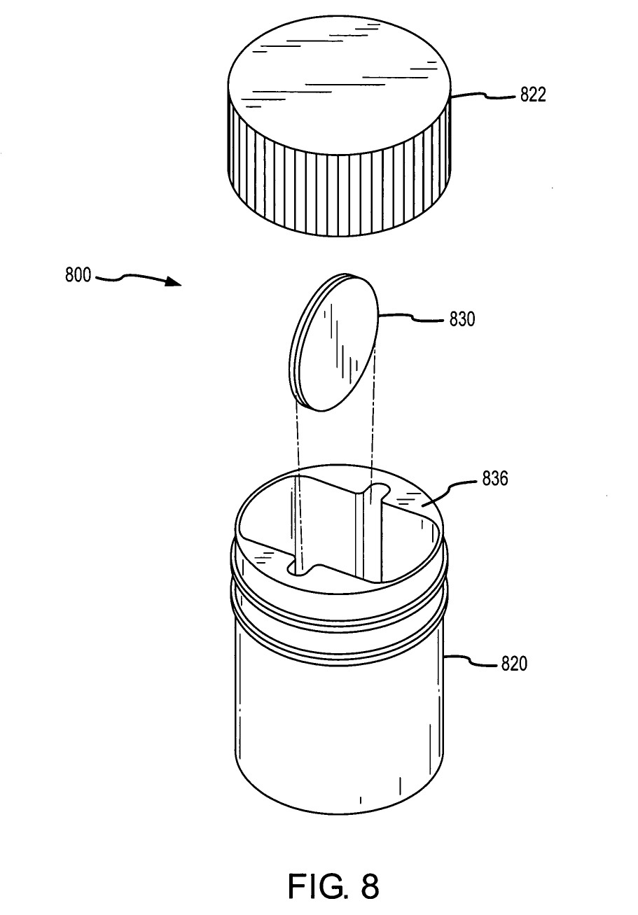

FIG. 8 is an exploded view of shipping container 800 in another example embodiment of the invention. Shipping container 800 comprises main body 820 and lid 822. Main body 820 has a cavity configured to hold fluid. Slot 836 is formed on the inner sides of the cavity. Lid 822 is configured to attach to main body 820 and seal the cavity, forming a water tight compartment in the shipping container. In operation, field replaceable part 830 is inserted into slot 836. Fluid is added to the cavity, immersing field replaceable part 830. Lid is attached to main body 820, thereby sealing the cavity. Lid may also be configured to hold field replaceable part into slot 836.

We claim:

1. A shipping container for a field replaceable part of a luminescent dissolved oxygen sensor, comprising:
a main body having a cavity, the cavity configure to hold fluid;
a lid configured to attach to the main body and seal the cavity thereby creating a water tight compartment with the main body;
a mounting system configured to hold a luminescent material, on the field replaceable part, in the cavity.

2. The shipping container of claim 1 where the mounting system is in the cavity.

3. The shipping container of claim 1 where the mounting system is on a bottom side of the lid.

4. The shipping container of claim 3 where the mounting system replicates a mounting system for the field replaceable part on the luminescent dissolved oxygen sensor.

5. The shipping container of claim 3 where the mounting system is a threaded stud and where the field replaceable part is held in the cavity by screwing the field replaceable part onto the threaded stud and then attaching the lid to the main body.

6. The shipping container of claim 1 further comprising:
a sponge configured to fit into the cavity and contact the luminescent material on the field replaceable part.

7. The shipping container of claim 1 where the mounting system forms a water tight seal against at least one area of the field replaceable part.

8. The shipping container of claim 7 where the field replaceable part is in the shape of a cap and the water tight seal prevents fluid from reaching an inside of the cap.

9. The shipping container of claim 7 where the field replaceable part is essentially flat and the water tight seal prevents fluid from reaching an area on a first side of the field replaceable part.

10. The shipping container of claim 1 further comprising:
a heat shrink sleeve configured to shrink around the lid and the main body thereby holding the lid onto the main body.

11. A method, comprising:
inserting a field replaceable part of a luminescent dissolved oxygen sensor into a cavity of a shipping container;
adding a fluid to the cavity of the sipping container;
sealing the cavity.

12. The method of claim 11 further comprising:
shipping the field replaceable part in the sealed cavity.

13. The method of claim 11 further comprising:
inserting a sponge into the cavity before inserting the field replaceable part.

14. The method of claim 11 where the luminescent material is immersed in fluid for a preset time before being inserted into the shipping container.

15. The method of claim 14 where the preset time is at least 3 days.

16. The method of claim 11 where the luminescent material is allowed to become saturated in the shipping container before the shipping container is shipped.

17. The method of claim 11 where the cavity is formed by a sealable bag.

18. The method of claim 11 where the cavity is formed by a main body and the cavity is sealed with a lid.

19. The method of claim 11 where the field replaceable part is held in the cavity by a mounting system.

20. The method of claim 19 where the mounting system is formed on a bottom side of a lid.

21. The method of claim 11 further comprising:
forming a seal around an area of the field replaceable part to prevent fluid from contacting the area before inserting the field replaceable part into the cavity.

22. A apparatus, comprising:
a bag, the bag configure to hold a fluid and sized to accept a luminescent material for a luminescent dissolved oxygen sensor;
the bag configured to be sealed with the luminescent material and fluid inside the bag such that a water tight cavity is formed;
a shipping container configured to hold the bag without breaking the water tight seal.

23. A method, comprising:
saturating a luminescent material on a field replaceable part of a luminescent dissolved oxygen sensor with a fluid for a predetermined time;
shipping the field replaceable part with the luminescent material continuously saturated.

24. A shipping container, comprising:
means for holding a luminescent material, for a luminescent dissolved oxygen sensor, immersed in a fluid;
means for protecting the holding means from damage during shipment.
